(19) United States
(12) Patent Application Publication
(10) Pub. No.: US 2012/0289442 A1
(43) Pub. Date: Nov. 15, 2012

(54) ARTICLES HAVING LOW COEFFICIENTS OF FRICTION, METHODS OF MAKING THE SAME, AND METHODS OF USE

(75) Inventors: Wallace Gregory Sawyer, Gainesville, FL (US); Brandon Alexander Krick, Gainesville, FL (US); Gregory Scott Blackman, Media, PA (US); Christopher P. Junk, Wilmington, DE (US)

(73) Assignees: E.I. DUPONT DE NEMOURS AND COMPANY, Wilmington, DE (US); UNIVERSITY OF FLORIDA RESEARCH FOUNDATION, INC., Gainesville, FL (US)

(21) Appl. No.: 13/470,402

(22) Filed: May 14, 2012

Related U.S. Application Data
(60) Provisional application No. 61/485,960, filed on May 13, 2011.
(60) Provisional application No. 61/485,965, filed on May 13, 2011.

(51) Int. Cl. C10M 161/00; B29C 43/00

(52) U.S. Cl. 508/138; 264/115

(57) ABSTRACT

Embodiments of the present disclosure provide for articles, compositions, methods for making articles, methods of using articles, and the like. Embodiments of the present disclosure relate to articles having superior tribological properties. In particular, embodiments of the present disclosure have a low coefficient of friction and a very low wear rate relative to polytetrafluoroethylene (PTFE).

### CROSS-REFERENCE TO RELATED APPLICATION

This application claims priority to U.S. provisional application entitled “ARTICLES HAVING LOW COEFFICIENTS OF FRICTION, METHODS OF MAKING THE SAME, AND METHODS OF USE,” having Ser. No. 61/485,960 filed on May 13, 2011, which is entirely incorporated herein by reference. This application claims priority to U.S. provisional application entitled “ARTICLES HAVING LOW COEFFICIENTS OF FRICTION, METHODS OF MAKING THE SAME, AND METHODS OF USE,” having Ser. No. 61/485,965, filed on May 13, 2011, which is entirely incorporated herein by reference.

### FEDERAL SPONSORSHIP

This invention was made with Government support under Contract/Grant No. FA9550-04-1-0367 awarded by the AFOSR MURI. The Government has certain rights in this invention.

### BACKGROUND

Solid lubrication offers many benefits over conventional oil-based hydrodynamic and boundary lubrication. Solid lubrication systems are generally more compact and less costly than oil lubricated systems since pumps, lines, filters and reservoirs are usually required in oil lubricated systems. Greases can contaminate the product of the system being lubricated, making it undesirable for food processing and both grease and oil outgas in vacuum precluding their use in space applications. Thus, there is a need in the art for solid lubricants.

### SUMMARY

Embodiments of the present disclosure provide for articles, compositions, methods for making articles, methods of using articles, and the like. Embodiments of the present disclosure relate to articles having superior tribological properties. In particular, embodiments of the present disclosure have a low coefficient of friction and a very low wear rate relative to polytetrafluoroethylene (PTFE).

In an exemplary embodiment, an article, among others, includes a composite including a fluoropolymer, metal oxide particles, and silica particles. In an embodiment, the metal oxide is one of α-alumina or rutile. In an embodiment, the article has a steady state wear rate of about 3×10⁻⁸ mm³/N-m or less, when measured at 6.25 MPa normal pressure and 50.8 mm/s sliding velocity against a lapped stainless steel countersurface. In an embodiment, the article has a steady state wear rate of about 1×10⁻⁷ mm³/Nm or less, when measured at 6.25 MPa normal pressure and 50.8 mm/s sliding velocity against a lapped stainless steel countersurface.

In an exemplary embodiment, a process for manufacturing an article comprising a composite portion, among others, includes: creating a composite powder material by a process comprising: creating a particle dispersion of additive particles comprising metal oxide particles and silica particles in a polar organic liquid, mixing the particle dispersion with fluoropolymer powder particles to form a precursor slurry, and drying the precursor slurry by removing the polar organic liquid to form the composite powder material, wherein the additive particles are associated with a surface of the fluoropolymer powder particles; and forming the composite powder material into the composite portion of the article.

In an exemplary embodiment, a composition, among others, includes a composite including a fluoropolymer, metal oxide particles, and silica particles.

### BRIEF DESCRIPTION OF THE DRAWINGS

Embodiment of the present disclosure may be more fully understood and further advantages may become apparent when reference is had to the following detailed description of the preferred embodiments of the present disclosure and the accompanying drawing.

FIG. 1 illustrates an apparatus suitable for a molding operation for producing a compacted body in accordance with the present disclosure.

FIG. 2 illustrates a tribometer suitable for carrying out sliding wear rate and coefficient of friction measurements in accordance with the present disclosure.

FIGS. 3A-3C are structures of certain perfluoroolefin monomers useful in the practice of the present process.

FIG. 4 depicts particle size distributions for a form of α-alumina useful as particles in the practice of the present process.

FIG. 5 depicts particle size distributions for a form of rutile TiO₂ useful as particles in the practice of the present process.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims. Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed. Terms defined in references that are incorporated by reference do not alter definitions of terms defined in the present disclosure or should such terms be used to define terms in the present disclosure they should only be used in a manner that is inconsistent with the present disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, physics, and the like, which are within the skill of the art. Such techniques are explained fully in the literature. Certain of the measurements discussed herein are carried out in accordance with recognized protocols specified by ASTM Standards, which are promulgated by ASTM International, West Conshohocken, Pa. Each such standard referenced herein is incorporated in its entirety by reference.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion

Embodiments of the present disclosure provide for articles, compositions, methods for making articles, methods of using articles, and the like. Embodiments of the present disclosure relate to articles having superior tribological properties. In particular, embodiments of the present disclosure have a low coefficient of friction and a very low wear rate relative to polytetrafluoroethylene (PTFE).

Embodiments of the present disclosure include compositions including a composite including a fluoropolymer and silica and metal oxide particles. The composition can be present in an article or can be the residual material (e.g., a transfer film) from an article.

Embodiments of the article can include a composite including a fluoropolymer and silica particles and particles such as alumina (e.g., α-alumina (Al₂O₃)) and/or titania (e.g., TiO₂ in the rutile form) particles. In an embodiment, the article can be free sintered, compression molded, or melt processed. In an embodiment, the composite can make up either 100% of the article or a portion of the article, such as a layer forming one or more surfaces of the overall article. Reference to characteristics of the article where the composite is not 100% of the article refers to characteristics measured relative to the composite interacting with another structure (e.g., the location of contact that produces the friction and form a residual transfer film).

In an embodiment, the article can have a steady state wear rate that is as much as about 10,000 times lower than that of PTFE or PTFE and solely fumed silica particles, and at least an order of magnitude better than a composition having PTFE and solely alumina particles. In an embodiment, the steady state wear rate of the article can be about 1×10⁻⁷ mm³/Nm or less, about 3×10⁻⁸ mm³/Nm or less, or about 1×10⁻⁷ mm³/Nm to 3×10⁻⁸, when measured at a nominal applied pressure of 6.25 MPa and 50.8 mm/s sliding velocity against a lapped 304 stainless steel counterface. In other embodiments, the steady state wear rate may be superior to these noted amounts.

In some embodiments, the filler material comprises submicron particles or nanoparticles. As used herein, the term “submicron particle” refers to a particle that is part of an ensemble of like particles having a size distribution, as measured in at least one dimension, that is characterized by a d₅₀ value (median size) of at most 0.5 μm (500 nm). The term “nanoparticle” refers to a particle that is part of an ensemble of like particles having a size distribution in at least one dimension that is characterized by a d₅₀ value of at most 0.1 μm (100 nm). Nanoparticles thus fall within the larger class of submicron particles.

In some cases, a portion of the starting particulate filler material comprises aggregated or agglomerated particles that are larger than the primary particle size. In an embodiment, the primary particle size may be about 100 nm or smaller, whereas the agglomerates may be as large as about 2 μm or more, as measured in at least one dimension. In another embodiment, the primary particle size may be about 50 nm or smaller and the agglomerates as large as about 10 μm or larger in at least one dimension. It is believed that some or all these large particles may break apart or deagglomerate subsequently, either during the formation of the fluoropolymer composite body, or as the particles are newly exposed at the bearing surface as a wear process proceeds. Thus, larger measures of particle size used herein to characterize a particulate filler material in its initial state, before it is incorporated into the present fluoropolymer composite body, do not necessarily persist in the composite body or in a transfer film formed therefrom, and smaller particles formed thereby may have smaller sizes.

A number of techniques are known in the art for characterizing the size of small particles by either direct or indirect measurements. It is known that different techniques give different size results for the same particles, especially ones that have non-spherical or irregular shape or a multi-modal distribution. For example, a widely-used indirect method is the Brunauer-Emmett-Teller (BET) technique, which provides a determination of the aggregate effective surface area of a known mass of particles, based on a measurement of the amount of gas that can be adsorbed on the surface of the ensemble of particles. The amount of gas is used to calculate a specific surface area of the ensemble (area per unit mass). By assuming the ensemble to consist of monodisperse, fully dense spheres, a characteristic size may be inferred. It will be appreciated that for BET measurements, the larger the surface area the smaller the equivalent or characteristic size.

However, particles that feature significant porosity will adsorb far more gas than they would based solely on their external dimensions, thus leading to an unrealistically small inferred size from the BET measurement. Similar, but likely smaller, discrepancies arise for particles that exhibit fractal, jagged, or otherwise irregular surfaces and thus enhanced surface area.

In an embodiment, particulate filler materials useful in the practice of the present disclosure may have a BET-determined specific surface area of at least about 22 m²/g. In other embodiments the material may have a BET-determined specific surface area of at least about 43 m²/g, at least about 7 m²/g, at least about 2 m²/g, or at least about 0.3 m²/g.

At the other extreme, direct imaging, e.g., using scanning or transmission electron microscopy, permits individual particles to be imaged and sized directly. Image analysis techniques can be applied to electron micrographs to quantify size distributions and shape characteristics, such as the departure from spherality. However, skilled interpretation may be needed to identify other crucial features, such as porosity, and to ascertain whether the object being visualized is a primary particle or an association of multiple primary particles, e.g., particles that have agglomerated or are joined more rigidly.

Radiation scattering techniques, including small-angle x-ray and neutron scattering and static or dynamic light scattering also can be used to determine ensemble averages and size distributions although broad or multimodal distributions and irregular shaped particles or distributions of shape complicate interpretation of the scattering data.

In one embodiment of a measuring technique, particle size may be measured by dynamic light scattering (DLS), which is typically carried out on particles prepared in a dilute suspension. A suitable instrument for the measurement is available commercially as a Microtrac Nanotrac Ultra particle size analyzer. The Nanotrac Ultra applies heterodyne detection using a 780 nm diode laser at an incident angle of 180 degrees.

In a typical data collection the background signal is first measured. A rigorously cleaned borosilicate glass vessel is filled with approximately 10 mL of the carrier fluid and equilibrated to room temperature. The Nanotrac optical probe is inserted and the background measured for 300 s using Microtrac Flex® software Set Zero function. The resulting loading index after background subtraction is nominally zero. The sample of interest is then loaded into the glass vessel until a suitable loading index is achieved within the concentration-independent loading regime. The sample temperature is equilibrated with the ambient environment prior to measurement. Each sample is run a sufficient number of times to obtain satisfactory data.

The autocorrelation function for each run is acquired from the instrument and interpreted by the software using low filtering and high sensitivity settings. Typically, each cumulative correlation function is fit using the method of cumulants to obtain the z-average diffusion coefficient and normalized second cumulant (polydispersity term). The z-average diffusion coefficient is then converted to an effective hydrodynamic diameter (or effective diameter) of the particles using the Stokes-Einstein expression and the known viscosity of water for the appropriate ambient temperature (e.g., 0.955 cP at 25° C.). The volume weighted distribution of the particles is derived in accordance with Mie Theory using the appropriate refractive index (e.g., 1.7 for alumina particles and 1.33 for the suspending aqueous solution). The volume distributions from all the runs are averaged to obtain final DLS results.

In another embodiment of a measuring technique, particle size may be measured by a static light scattering (SLS) method, which is likewise typically carried out on particles prepared in a dilute suspension in liquid. A suitable instrument for this measurement is available commercially as a Beckman Coulter LS13 320 Particle Size Analyzer. This instrument operates at multiple wavelengths, combining 780 nm laser diffraction with Polarized Intensity Differential Scattering (PIDS) at 450 nm, 600 nm and 900 nm. The Mie Theory for light scattering is applied through software to calculate the particle size distributions using an assumed complex refractive index of 1.7; 0.01i.

Various statistical characterizations can be derived from particle distribution data obtained using either dynamic or static light scattering. The d₅₀ or median particle size by volume is commonly used to represent the approximate particle size. Other common statistically derived measures of particle size include d₁₀ and d₉₀. It is to be understood that 10 vol. % and 90 vol. % of the particles in the ensemble have a size less than d₁₀ and d₉₀, respectively. These values, taken either singly or in combination with the d₅₀ values, can provide additional characterization of a particle distribution, which is especially useful for a distribution that is not symmetrical, or is multimodal, or complex.

It is to be noted that in some instances, particle size distributions obtained with different techniques show subtle differences. These differences are generally more pronounced for ensembles in which the particles are non-spherical, irregularly shaped, multi-modal, or not fully dense. For example, dynamic light scattering measurements of submicron particle ensembles typically are insensitive to the presence of particles above 1 μm, such as particles resulting from the aggregation or agglomeration of smaller primary particles, which may be revealed in micrographs or in static light scattering. Particles in such ensembles are nevertheless regarded as submicron particles useful in the practice of the present invention, provided that their d₅₀ values are less than 500 nm, as discussed hereinabove.

In an embodiment, the particles of filler materials useful in the practice of the present disclosure may have a median particle size by volume (d₅₀) determined by dynamic light scattering of about 500 nm or less, 220 nm or less, 120 nm or less, or 70 nm or less. In some embodiments, the d₅₀ value determined by dynamic light scattering may be at least about 50 nm, at least about 70 nm, or at least about 100 nm. Further embodiments may have a filler particle size distribution wherein the d₅₀ value is in the range from about 50 to 500 nm, or about 70 to 500 nm, or about 100 to 220 nm. The primary particle size of the particles of the filler material in some embodiments may be about 10-30 nm, about 30-50 nm, or about 30-60 nm.

Although particulate filler materials having average particle sizes below about 100 nm can be prepared by processes that entail use of grinding, crushing, milling, or other mechanical processes to make small particles from larger precursors, chemical synthesis, gas-phase synthesis, condensed phase synthesis, high speed deposition by ionized cluster beams, consolidation, deposition and sol-gel methods may also be used, and may be easier to use, for such purpose.

In another embodiment, the particles of filler materials useful in the practice of the present disclosure may have a median particle size by volume (d₅₀) determined by static light scattering of about 1500 nm or less, 500 nm or less, or 200 nm or less. In some embodiments, the d₅₀ value determined by static light scattering may be at least about 80 nm, at least about 100 nm, or at least about 200 nm.

In still other embodiments, the particles of filler materials useful in the practice of the present disclosure exhibit a size distribution characterized by a d₉₀ value measured by dynamic light scattering of about 1000 nm or less, 500 nm or less, 330 nm or less.

In yet other embodiments, the particles of filler materials useful in the practice of the present disclosure exhibit a size distribution characterized by a combination of more than one of the foregoing measures, e.g., by at least two of; d₅₀ measured by dynamic light scattering, d₅₀ measured by static light scattering, d₉₀ measured by dynamic light scattering, d₉₀ measured by static light scattering, and an effective average size measured by the BET method. For example, in an embodiment, the particles exhibit a d₅₀ measured by dynamic light scattering of 220 nm or less and a d₉₀ measured by dynamic light scattering of 330 nm or less. In another embodiment, the particles exhibit a d₅₀ measured by dynamic light scattering of 220 nm or less and a d₅₀ measured by static light scattering of 340 nm or less. In still another embodiment, the particles exhibit a d₅₀ measured by dynamic light scattering of 220 nm or less and an effective average particle size of 80 nm as measured by the BET method. All such combinations of size requirements set forth above are understood to be within the scope of embodiments of the present disclosure.

An example of the complementary nature of the different ways to characterize particle size is provided by a submicron α-alumina (Stock #44652, Alfa Aesar, Ward Hill, Mass.) which has been found to be useful in the present composite. FIG. 2 provides particle size distribution data obtained for this material by both static and dynamic light scattering. Values of d₅₀, d₁₀, and d₉₀ (in nm) obtained from these distributions are set forth in Table I below. The same material is indicated by the manufacturer to have a particle size of 60 nm, although the test method is not identified. It may be seen that both DLS and SLS demonstrate a particle size larger than the 60 nm indicated by the manufacturer. The peak seen in the SLS distribution at about 2000 nm is believed to further indicate the presence of an appreciable number of substantially agglomerated or aggregated particles not separated during the sonication applied. DLS is insensitive to these large particles, and their contribution somewhat shifts the determination of d₅₀, d₁₀, and d₉₀ in the SLS data from the corresponding values derived from the DLS data. Nevertheless, this alumina material still may be considered submicron particles because the d₅₀, even as measured by static light scattering, is less than 500 nm.

TABLE I
Characterization of Particle Size Distribution of an α-alumina

| | DLS | SLS |
|---|---|---|
| d₅₀ | 219 nm | 335 nm |
| d₁₀ | 110 nm | 176 nm |
| d₉₀ | 330 nm | 1.52 μm |

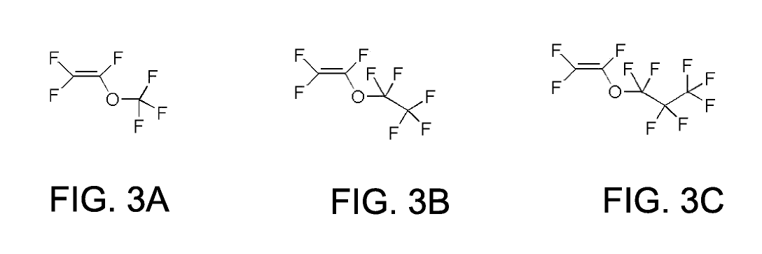

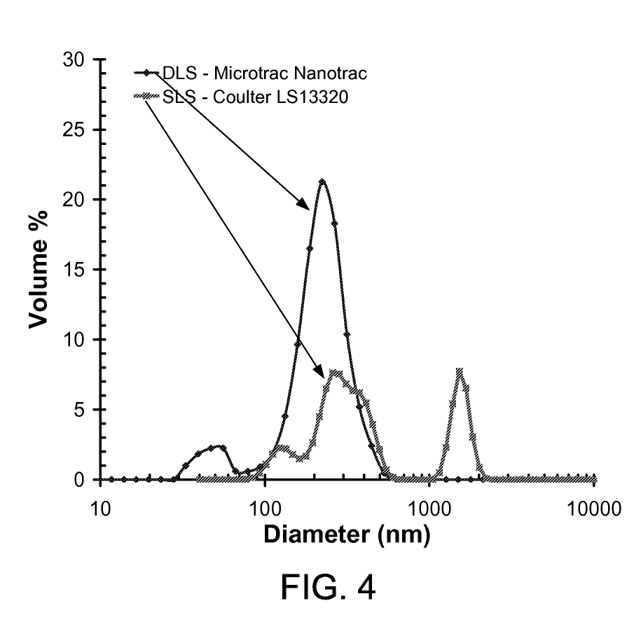

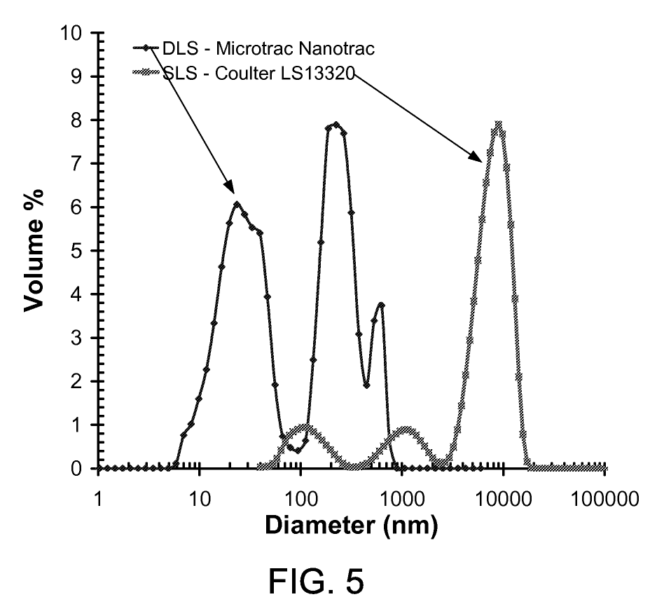

A rutile-form of TiO₂ found useful as a submicron particulate filler yields SLS and DLS data shown in FIG. 3 and in Table II below.

TABLE II
Characterization of Particle Size Distribution of TiO₂

| | DLS | SLS |
|---|---|---|
| d₅₀ | 116 nm | 7.4 μm |
| d₁₀ | 18.4 nm | 214 nm |
| d₉₀ | 400 nm | 12.4 μm |

These data represent another example of the differences in the data provided by the SLS and DLS methods for particles useful in the practice of the present disclosure. The peak at around 10 μm in the SLS-determined distribution may indicate that at least some of the primary particles are substantially aggregated or agglomerated.

In an embodiment, the present composite includes alumina particles as about 0.1 to 30 or about 0.5 to 20 weight percent of the composite (or composition).

In an embodiment, the silica particles of the present composite can include submicron silica particles or silica nanoparticles as described herein. In an embodiment, silica particles can include fumed silica particles, in particular, fumed silica nanoparticles. In an embodiment, the silica particles can be about 0.1 to 30 or about 1 to 20 weight percent of the composite (or composition). Commercially available fumed silica materials are commonly found to comprise particles that are aggregations or agglomerations of multiple primary particles.

Fluoropolymers are used herein to prepare a polymeric composite by admixture with a metal oxide or other suitable particulate. For that purpose an individual fluoropolymer can be used alone; mixtures or blends of two or more different kinds of fluoropolymers can be used as well. Fluoropolymers useful in the practice of this disclosure are prepared from at least one unsaturated fluorinated monomer (fluoromonomer). A fluoromonomer suitable for use herein preferably contains about 35 wt % or more fluorine, and preferably about 50 wt % or more fluorine, and can be an olefinic monomer with at least one fluorine or fluoroalkyl group or fluoroalkoxy group attached to a doubly-bonded carbon. In one embodiment, a fluoromonomer suitable for use herein is tetrafluoroethylene (TFE).

An especially useful fluoropolymer is thus polytetrafluoroethylene (PTFE), which refers to (a) polymerized tetrafluoroethylene by itself without any significant comonomer present, i.e. a homopolymer of TFE, and (b) modified PTFE, which is a copolymer of TFE with such small concentrations of comonomer that the melting point of the resultant polymer is not substantially reduced below that of PTFE (reduced, for example, by about 8% or less, about 4% or less, about 2% or less, or about 1% or less). Modified PTFE contains a small amount of comonomer modifier that improves film forming capability during baking (fusing). Comonomers useful for such purpose typically are those that introduce bulky side groups into the molecule, and specific examples of such monomers are described below. The concentration of such comonomer is preferably less than 1 wt %, and more preferably less than 0.5 wt %, based on the total weight of the TFE and comonomer present in the PTFE. A minimum amount of at least about 0.05 wt % comonomer is preferably used to have a significant beneficial effect on processability. The presence of the comonomer is believed to cause a lowering of the average molecular weight.

PTFE (and modified PTFE) typically have a melt creep viscosity of at least about 1×10⁶ Pa·s and preferably at least about 1×10⁸ Pa·s. With such high melt viscosity, the polymer does not flow in the molten state and therefore is not a melt-processible polymer. The measurement of melt creep viscosity is disclosed in col. 4 of U.S. Pat. No. 7,763,680. The high melt viscosity of PTFE arises from its extremely high molecular weight (Mn), e.g., at least about 10⁶. Additional indicia of this high molecular weight include the high melting temperature of PTFE, which is at least 330° C., usually at least 331° C. and most often at least 332° C. (all measured on first heat). The non-melt flowability of the PTFE, arising from its extremely high melt viscosity, manifests itself as a melt flow rate (MFR) of 0 when measured in accordance with ASTM D 1238-10 at 372° C. and using a 5 kg weight. This high melt viscosity also leads to a much lower heat of fusion obtained for the second heat (e.g., up to 55 J/g) as compared to the first heat (e.g., at least 75 J/g) to melt the PTFE, representing a difference of at least 20 J/g. The high melt viscosity of the PTFE reduces the ability of the molten PTFE to recrystallize upon cooling from the first heating. The high melt viscosity of PTFE enables its standard specific gravity (SSG) to be measured, which measurement procedure (ASTM D 4894-07, also described in U.S. Pat. No. 4,036,802) includes sintering the SSG sample free standing (without containment) above its melting temperature without change in dimension of the SSG sample. The SSG sample does not flow during the sintering.

Low molecular weight PTFE is commonly known as PTFE micropowder, which distinguishes it from the PTFE described above. The molecular weight of PTFE micropowder is low relative to PTFE, i.e. the molecular weight (Mn) is generally in the range of 10⁴ to 10⁵. The result of this lower molecular weight of PTFE micropowder is that it has fluidity in the molten state, in contrast to PTFE which is not melt flowable. The melt flowability of PTFE micropowder can be characterized by a melt flow rate (MFR) of at least about 0.01 g/10 min, preferably at least about 0.1 g/10 min, more preferably at least about 5 g/10 min, and still more preferably at least about 10 g/10 min., as measured in accordance with ASTM D 1238-10, at 372° C. using a 5 kg weight on the molten polymer.

While PTFE micropowder is characterized by melt flowability because of its low molecular weight, the PTFE micropowder by itself is not melt fabricable, i.e. an article molded from the melt of PTFE micropowder has extreme brittleness, and an extruded filament of PTFE micropowder, for example, is so brittle that it breaks upon flexing. Because of its low molecular weight (relative to non-melt-flowable PTFE), PTFE micropowder has no strength, and compression molded plaques for tensile or flex testing generally cannot be made from PTFE micropowder because the plaques crack or crumble when removed from the compression mold, which prevents testing for either the tensile property or the MIT Flex Life. Accordingly, the micropowder is assigned zero tensile strength and an MIT Flex Life of zero cycles. In contrast, PTFE is flexible, rather than brittle, as indicated for example by an MIT flex life [ASTM D-2176-97a(2007)], using an 8 mil (0.21 mm) thick compression molded film] of at least 1000 cycles, preferably at least 2000 cycles. As a result, PTFE micropowder finds use as a blend component with other polymers such as PTFE itself and/or copolymers of TFE with other monomers such as those described below.

In other embodiments, a fluoromonomer suitable for use herein, by itself to prepare a homopolymer or in copolymerization with other comonomers such as TFE, can be represented by the structure of the following Formula I:

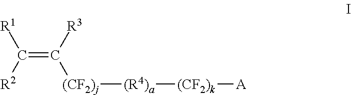

wherein R¹ and R² are each independently selected from H, F and Cl;
R³ is H, F, or a C₁˜C₁₂, or C₁˜C₈, or C₁˜C₆, or C₁˜C₄ straight-chain or branched, or a C₃˜C₁₂, or C₃˜C₈, or C₃˜C₆ cyclic, substituted or unsubstituted, alkyl radical; R⁴ is a C₁˜C₁₂, or C₁˜C₈, or C₁˜C₆, or C₁˜C₄ straight-chain or branched, or a C₃˜C₁₂, or C₃˜C₈, or C₃˜C₆ cyclic, substituted or unsubstituted, alkylene radical; A is H, F or a functional group; a is 0 or 1; and j and k are each independently 0 to 10; provided that, when a, j and k are all 0, at least one of R¹, R², R³ and A is not F.

An unsubstituted alkyl or alkylene radical as described above contains no atoms other than carbon and hydrogen. In a substituted hydrocarbyl radical, one or more halogens selected from Cl and F can be optionally substituted for one or more hydrogens; and/or one or more heteroatoms selected from O, N, S and P can optionally be substituted for any one or more of the in-chain (i.e. non-terminal) or in-ring carbon atoms, provided that each heteroatom is separated from the next closest heteroatom by at least one and preferably two carbon atoms, and that no carbon atom is bonded to more than one heteroatom. In other embodiments, at least 20%, or at least 40%, or at least 60%, or at least 80% of the replaceable hydrogen atoms are replaced by fluorine atoms. Preferably a Formula I fluoromonomer is perfluorinated, i.e. all replaceable hydrogen atoms are replaced by fluorine atoms.

In a Formula I compound, a linear R³ radical can, for example, be a C_{b} radical where b is 1, 2, 3, 4, 5, 6, 7, 8, 9, 10, 11 or 12 and the radical can contain from 1 up to 2b+1 fluorine atoms. For example, a C₄ radical can contain from 1 to 9 fluorine atoms. A linear R³ radical is perfluorinated with 2b+1 fluorine atoms, but a branched or cyclic radical will be perfluorinated with fewer than 2b+1 fluorine atoms. In a Formula I compound, a linear R⁴ radical can, for example, be a C_{c} radical where c is 1, 2, 3, 4, 5, 6, 7, 8, 9, 10, 11 or 12 and the radical can contain from 1 to 2c fluorine atoms. For example, a C₆ radical can contain from 1 to 12 fluorine atoms. A linear R⁴ radical is perfluorinated with 2c fluorine atoms, but a branched or cyclic radical will be perfluorinated with fewer than 2c fluorine atoms.

Examples of a C₁˜C₁₂ straight-chain or branched, substituted or unsubstituted, alkyl or alkylene radical suitable for use herein can include or be derived from a methyl, ethyl, n-propyl, i-propyl, n-butyl, sec-butyl, tert-butyl, n-pentyl, n-hexyl, n-octyl, trimethylpentyl, allyl and propargyl radical. Examples of a C₃˜C₁₂ cyclic aliphatic, substituted or unsubstituted, alkyl or alkylene radical suitable for use herein can include or be derived from an alicyclic functional group containing in its structure, as a skeleton, cyclohexane, cyclooctane, norbornane, norbornene, perhydro-anthracene, adamantane, or tricyclo-[5.2.1.0^{2.6}]-decane groups.

Functional groups suitable for use herein as the A substituent in Formula I include ester, alcohol, acid (including carbon-, sulfur-, and phosphorus-based acid) groups, and the salts and halides of such groups; and cyanate, carbamate, and nitrile groups. Specific functional groups that can be used include —SO₂F, —CN, —COOH, and —CH₂—Z wherein —Z is —OH, —OCN, —O—(CO)—NH₂, or —OP(O)(OH)₂.

Formula I fluoromonomers that can be homopolymerized include vinyl fluoride (VF), to prepare polyvinyl fluoride (PVF), and vinylidene fluoride (VF₂) to prepare polyvinylidene fluoride (PVDF), and chlorotrifluoroethylene to prepare polychlorotrifluoroethylene. Examples of Formula I fluoromonomers suitable for copolymerization include those in a group such as ethylene, propylene, 1-butene, 1-hexene, 1-octene, chlorotrifluoroethylene (CTFE), trifluoroethylene, hexafluoroisobutylene, vinyl fluoride (VF), vinylidene fluoride (VF₂), and perfluoroolefins such as hexafluoropropylene (HFP), and perfluoroalkyl ethylenes such as perfluoro(butyl)ethylene (PFBE). A preferred monomer for copolymerization with any of the above named comonomers is tetrafluoroethylene (TFE).

In yet other embodiments, a fluoromonomer suitable for use herein, by itself to prepare a homopolymer or in copolymerization with TFE and/or any of the other comonomers described above, can be represented by the structure of the following Formula II:

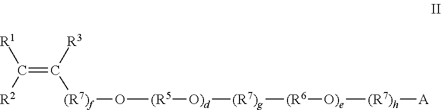

wherein R¹ through R³ and A are each as set forth above with respect to Formula I; d and e are each independently 0 to 10; f, g and h are each independently 0 or 1; and R⁵ through R⁷ are the same radicals as described above with respect to R⁴ in Formula I except that when d and e are both non-zero and g is zero, R⁵ and R⁶ are different R⁴ radicals.

Formula II compounds introduce ether functionality into fluoropolymers suitable for use herein, and include fluorovinyl ethers such as those represented by the following formula: CF₂═CF—(O—CF₂CFR¹¹)ₕ—O—CF₂CFR¹²SO₂F, wherein R¹¹ and R¹² are each independently selected from F, Cl or a perfluorinated alkyl group having 1 to 10 carbon atoms, and h=0, 1 or 2. Examples of polymers of this type that are disclosed in U.S. Pat. No. 3,282,875 include CF₂═CF—O—CF₂CF(CF₃)—O—CF₂CF₂SO₂F and perfluoro(3,6-dioxa-4-methyl-7-octenesulfonyl fluoride), and examples that are disclosed in U.S. Pat. Nos. 4,358,545 and 4,940,525 include CF₂═CF—O—CF₂CF₂SO₂F. Another example of a Formula II compound is CF₂═CF—O—CF₂—CF(CF₃)—O—CF₂CF₂CO₂CH₃, the methyl ester of perfluoro(4,7-dioxa-5-methyl-8-nonenecarboxylic acid), as disclosed in U.S. Pat. No. 4,552,631. Similar fluorovinyl ethers with functionality of nitrile, cyanate, carbamate, and phosphonic acid are disclosed in U.S. Pat. Nos. 5,637,748, 6,300,445 and 6,177,196. Methods for making fluoroethers suitable for use herein are set forth in the U.S. patents listed above in this paragraph, and each of the U.S. patents listed above in this paragraph is by this reference incorporated in its entirety as a part hereof for all purposes.

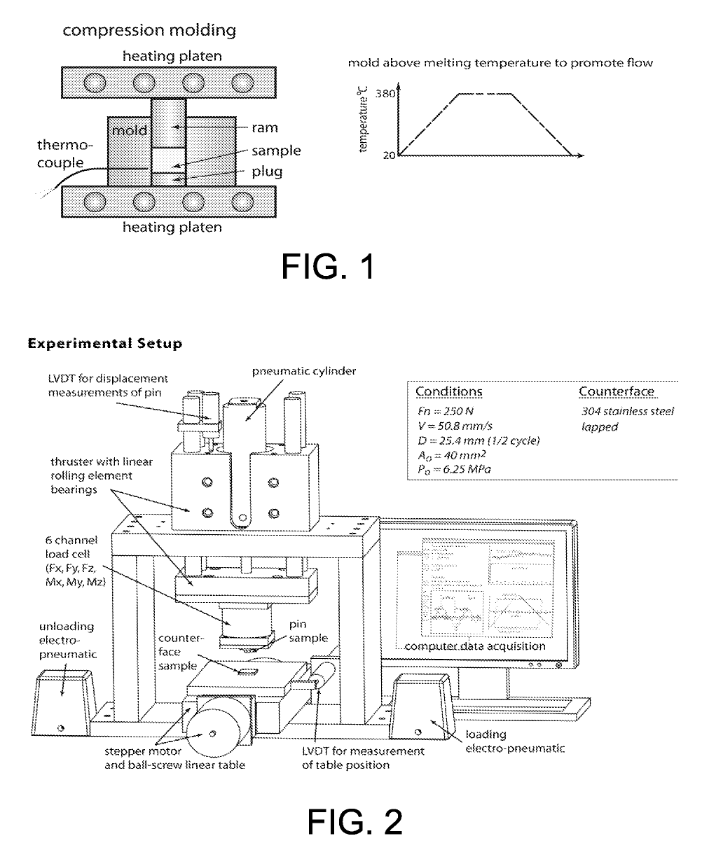

Particular Formula II compounds suitable for use herein as a comonomer include fluorovinyl ethers such as perfluoro(allyl vinyl ether) and perfluoro(butenyl vinyl ether). Preferred fluorovinyl ethers include perfluoro(alkyl vinyl ethers) (PAVE), where the alkyl group contains 1 to 5 carbon atoms, with perfluoro(ethyl vinyl ether) (PEVE) and perfluoro(propyl vinyl ether) (PPVE), and perfluoro(methyl vinyl ether) (PMVE) being preferred. The structures of these preferred fluorovinyl ethers are respectively depicted by FIGS. 1A-1C.

In yet other embodiments, a fluoromonomer suitable for use herein, by itself to prepare a homopolymer or in copolymerization with TFE and/or any of the other comonomers described above, can be represented by the structure of the following Formula III:

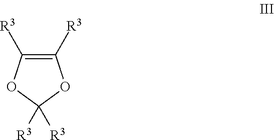

wherein each R³ is independently as described above in relation to Formula I. Suitable Formula III monomers include perfluoro-2,2-dimethyl-1,3-dioxole (PDD).

In yet other embodiments, a fluoromonomer suitable for use herein, by itself to prepare a homopolymer or in copolymerization with TFE and/or any of the other comonomers described above, can be represented by the structure of the following Formula IV:

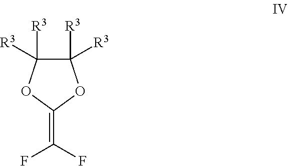

wherein each R³ is independently as described above in relation to Formula I. Suitable Formula IV monomers include perfluoro-2-methylene-4-methyl-1,3-dioxolane (PMD).

In various embodiments, fluoropolymer copolymers suitable for use herein can be prepared from any two, three, four or five of these monomers: TFE and a Formula I, II, III and IV monomer. The following are thus representative combinations that are available: TFE/Formula I; TFE/Formula II; TFE/Formula III; TFE/Formula IV; TFE/Formula I/Formula II; TFE/Formula I/Formula III; TFE/Formula I/Formula IV; Formula I/Formula II; Formula I/Formula III; and Formula I/Formula IV. Provided that at least two of the five kinds of monomers are used, a unit derived from each monomer can be present in the final copolymer in an amount of at least about 1 wt %, or at least about 5 wt %, or at least about 10 wt %, or at least about 15 wt %, or at least about 20 wt %, and yet no more than about 99 wt %, or no more than about 95 wt %, or no more than about 90 wt %, or no more than about 85 wt %, or no more than about 80 wt % (based on the weight of the final copolymer); with the balance being made up of one, two, three or all of the other five kinds of monomers.

A fluoropolymer as used herein can also be a mixture of two or more of the homo- and/or copolymers described above, which is usually achieved by dry blending. A fluoropolymer as used herein can also, however, be a polymer alloy prepared from two or more of the homo- and/or copolymers described above, which can be achieved by melt kneading the polymer together such that there is mutual dissolution of the polymer, chemical bonding between the polymers, or dispersion of domains of one of the polymers in a matrix of the other.

Tetrafluoroethylene polymers suitable for use herein can be produced by aqueous polymerization (as described in U.S. Pat. No. 3,635,926) or polymerization in a perhalogenated solvent (U.S. Pat. No. 3,642,742) or hybrid processes involving both aqueous and perhalogenated phases (U.S. Pat. No. 4,499,249). Free radical polymerization initiators and chain transfer agents are used in these polymerizations and have been widely discussed in the literature. For example, persulfate initiators and alkane chain transfer agents are described for aqueous polymerization of TFE/PAVE copolymers. Fluorinated peroxide initiators and alcohols, halogenated alkanes, and fluorinated alcohols are described for nonaqueous or aqueous/nonaqueous hybrid polymerizations.

Various fluoropolymers suitable for use herein include those that are thermoplastic, which are fluoropolymers that, at room temperature, are below their glass transition temperature (if amorphous), or below their melting point (if semi-crystalline), and that become soft when heated and become rigid again when cooled without the occurrence of any appreciable chemical change. A semi-crystalline thermoplastic fluoropolymer can have a heat of fusion of at least about 1 J/g, or at least about 4 J/g, or at least about 8 J/g, when measured by Differential Scanning calorimetry (DSC) at a heating rate of 10° C./min (according to ASTM D 3418-08). Various fluoropolymers suitable for use herein can additionally or alternatively be characterized as melt-processible, and melt-processible fluoropolymers can also be melt-fabricable. A melt-processible fluoropolymer can be processed in the molten state, i.e. fabricated from the melt using conventional processing equipment such as extruders and injection molding machines, into shaped articles such as films, fibers and tubes. A melt-fabricable fluoropolymer can be used to produce fabricated articles that exhibit sufficient strength and toughness to be useful for their intended purpose despite having been processed in the molten state. This useful strength is often indicated by a lack of brittleness in the fabricated article, and/or an MIT Flex Life of at least about 1000 cycles, or at least about 2000 cycles (measured as described above), for the fluoropolymer itself.

Examples of thermoplastic, melt-processible and/or melt-fabricable fluoropolymers include copolymers of tetrafluoroethylene (TFE) and at least one fluorinated copolymerizable monomer (comonomer) present in the polymer in sufficient amount to reduce the melting point of the copolymer below that of PTFE, e.g., to a melting temperature no greater than 315° C. Such a TFE copolymer typically incorporates an amount of comonomer into the copolymer in order to provide a copolymer which has a melt flow rate (MFR) of at least about 1, or at least about 5, or at least about 10, or at least about 20, or at least about 30, and yet no more than about 100, or no more than about 90, or no more than about 80, or no more than about 70, or no more than about 60, as measured according to ASTM D-1238-10 using a weight on the molten polymer and melt temperature which is standard for the specific copolymer. Preferably, the melt viscosity is at least about 10² Pa·s, more preferably, will range from about 10² Pa·s to about 10⁶ Pa·s, most preferably about 10³ to about 10⁵ Pa·s. Melt viscosity in Pa·s is 531,700/MFR in g/10 min.

In general, thermoplastic, melt-processible and/or melt-fabricable fluoropolymers as used herein include copolymers that contain at least about 40 mol %, or at least about 45 mol %, or at least about 50 mol %, or at least about 55 mol %, or at least about 60 mol %, and yet no more than about 99 mol %, or no more than about 90 mol %, or no more than about 85 mol %, or no more than about 80 mol %, or no more than about 75 mol % TFE; and at least about 1 mol %, or at least about 5 mol %, or at least about 10 mol %, or at least about 15 mol %, or at least about 20 mol %, and yet no more than about 60 mol %, or no more than about 55 mol %, or no more than about 50 mol %, or no more than about 45 mol %, or no more than about 40 mol % of at least one other monomer. Suitable comonomers to polymerize with TFE to form melt-processible fluoropolymers include a Formula I, II, III and/or IV compound; and, in particular, a perfluoroolefin having 3 to 8 carbon atoms [such as hexafluoropropylene (HFP)], and/or perfluoro(alkyl vinyl ethers) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers. Preferred TFE copolymers include FEP (TFE/HFP copolymer), PFA (TFE/PAVE copolymer), TFE/HFP/PAVE wherein PAVE is PEVE and/or PPVE, MFA (TFE/PMVE/PAVE wherein the alkyl group of PAVE has at least two carbon atoms) and THV (TFE/HFP/VF₂). Additional melt-processible fluoropolymers are the copolymers of ethylene (E) or propylene (P) with TFE or chlorinated TFE (CTFE), notably ETFE, ECTFE and PCTFE. Also useful in the same manner are film-forming polymers of polyvinylidene fluoride (PVDF) and copolymers of vinylidene fluoride as well as polyvinyl fluoride (PVF) and copolymers of vinyl fluoride.

An aspect of the present disclosure provides a slurry-based technique for dispersing additive particles (e.g., alumina or silica particles) in a fluoropolymer matrix and the material produced thereby. In an embodiment, the additive particles (submicron or nanoparticles) are first dispersed in a polar organic liquid. The particle dispersion is then mixed with fluoropolymer powder particles and the combination is processed to create a precursor slurry in which the additive particles are substantially uniformly dispersed. The slurry is then dried, typically under a combination of vacuum and heating, to form a composite powder material, in which the additive particles are associated with the surface of the fluoropolymer powder particles. The composite powder preferably is free flowing.

In an implementation of the present process, the particle dispersion is formed by combining the additive particles and the polar organic liquid in a suitable vessel and then imparting mechanical energy to the combination. In an embodiment, the mechanical energy is provided by sonication, meaning an exposure to a source of ultrasonic energy. Preferably, the intensity and time of the exposure is sufficient to cause the submicron particles to become substantially fully dispersed in the polar organic liquid. Alternatively, the energy may be supplied by any other suitable high-energy mixing technique, including without limitation high vortex or high shear mixing.

In an embodiment, the particle dispersion remains stable for a time sufficient for the formation of the dried composite powder material. Various effects, including particle shape, size, and composition, and the polar organic liquid used, alter the forces governing particle interactions, and thus the stability of the particle dispersion.

A precursor slurry is formed by combining the particle dispersion and particles of a desired fluoropolymer. The term “particle,” as used herein with reference to fluoropolymer compositions, refers to any divided form, including, without limitation, powder, granules, shavings, and pellets. The particles may have any characteristic dimensions consistent with adequate blending and dispersion of the additive particles in a final composite body produced using the composite powder material. In an embodiment, the fluoropolymer particles may have characteristic dimensions of about 100 nm to several mm. It has been found that in some embodiments smaller fluoropolymer particles are beneficially employed to promote good dispersion of the additive particles. It is believed that improving the dispersion of the additive particles on the starting fluoropolymer powder results in better dispersion of the additive particles in the final composite body, leading in turn to better ultimate mechanical properties of the final body.

A variety of polar organic liquids are useful in creating the particle dispersion and precursor slurry from which the present composite powder material and fluoropolymer composite body are produced. Suitable polar organic liquids include, but are not limited to, lower alcohols, such as methanol, ethanol, isopropanol (IPA), n-butanol, and tert-butanol. Other polar organic liquids are useful as well, including N,N-dimethylacetamide (DMAc), esters, or ketones. In certain preferred embodiments, IPA is used.

For example, embodiments based on fluoropolymers that are not melt processible can be made by a sintering or molding technique, in which the components are first mixed (e.g., by mechanical mixing, dispersion in a liquid, or other forms of mixing). The mixture is then transferred to a molding chamber where it is consolidated with pressure. In an implementation, the molding is done at a pressure of about 20 to 200 MPa for about 10 seconds to 10 minutes and thereafter the fluoropolymer is heated to above its melting point, held for a period of time (e.g., about 10 minutes to 10 hrs) to permit the fluoropolymer to sinter, and then cooled to ambient temperature. FIG. 1 illustrates one form of molding apparatus suitable for this process, along with a possible temperature profile for the sintering. The sintering operation can be carried out under continued application of compression (denominated herein as “compression molding”) or as a free sintering, i.e., without continued application of a compressive force. One possible implementation of a free sintering manufacture is set forth in ASTM Standard No. 1238-10. In other implementations, the consolidation is carried out at a pressure of about 20 to 250 MPa for a time of about 10 sec to 10 min. The sintering may be accomplished by ramping the temperature at a rate of about 2° C. per minute to a preselected temperature of about 360° C. to 390° C. and held for a period of about 1 to 10 hrs) and then cooled (e.g., at about 2° C. per minute) down to room temperature. Optionally, the compressive pressure is maintained during the sintering.

Other methods of making the article are also contemplated within the scope of the present disclosure. For example, alternative embodiments provide fluoropolymer composite bodies formed by melt processing the composite powder material. In some implementations, the melt processing comprises a multistage process, in which an intermediate is first produced in the form of powder, granules, pellets, or the like, and thereafter remelted and formed into an article of manufacture having a desired final shape. In an implementation, the intermediate is formed by a melt compounding or blending operation that comprises transformation of a thermoplastic resin from a solid pellet, granule or powder into a molten state by the application of thermal or mechanical energy. Requisite additive materials, such as composite powder material bearing fluoropolymers and particle additives (e.g., silica and alumina) prepared as described herein, may be introduced during the compounding or mixing process, before, during, or after the polymer matrix has been melted or softened. The compounding equipment then provides sufficient mechanical energy to provide sufficient stress to disperse the ingredients in the compositions, move the polymer, and distribute the additives to form a homogeneous mixture.

Melt blending can be accomplished with batch mixers (e.g., mixers available from Haake, Brabender, Banbury, DSM Research, and other manufacturers) or with continuous compounding systems, which may employ extruders or planetary gear mixers. Suitable continuous process equipment includes co-rotating twin screw extruders, counter-rotating twin screw extruders, multi-screw extruders, single screw extruders, co-kneaders (reciprocating single screw extruders), and other equipment designed to process viscous materials. Batch and continuous processing hardware suitable for carrying out steps of the present method may impart sufficient thermal and mechanical energy to melt specific components in a blend and generate sufficient shear and/or elongational flows and stresses to break solid particles or liquid droplets and then distribute them uniformly in the major (matrix) polymer melt phase. Ideally, such systems are capable of processing viscous materials at high temperatures and pumping them efficiently to downstream forming and shaping equipment. It is desirable that the equipment also be capable of handling high pressures, abrasive wear and corrosive environments. Compounding systems used in the present method typically pump a formulation melt through a die and pelletizing system.

The intermediate may be formed into an article of manufacture having a desired shape using techniques such as injection molding, blow molding, extruded film casting, blown film, fiber spinning, stock shape extrusion, pipe and tubing extrusion, thermoforming, compression molding, or the like, accomplished using suitable forming equipment.

Such embodiments may require that the fluoropolymer powder particles used to form the slurry and composite powder material be composed of a melt-processible fluoropolymer.

In other implementations, material produced by the melt-blending or compounding step is immediately melt processed into a desired shape, without first being cooled or formed into powder, granules, or the like. For example, in-line compounding and injection molding systems combine twin-screw extrusion technology in an injection molding machine so that the matrix polymer and other ingredients experience only one melt history.

In other embodiments, materials produced by shaping operations, including melt processing and forming, compression molding or sintering, may be machined into final shapes or dimensions. In still other implementations, the surfaces of the parts may be finished by polishing or other operations.

In still other embodiments, the composite powder material is used as a carrier material by which the particles (e.g., silica and alumina) are introduced into a matrix that may include an additional amount of the same fluoropolymer used in the composite powder material, one or more other fluoropolymers, or both. For example, the composite powder material may be formed using the present slurry technique with a first fluoropolymer powder material that is not melt-processible, with the intermediate thereafter blended with a second, melt-processible fluoropolymer powder. In an embodiment, the proportions of the two polymers are such that the overall blend is melt-processible. Other embodiments may entail more than two blended fluoropolymers. Alternatively, the intermediate is formed with a non-melt processible fluoropolymer and thereafter combined with more of the same fluoropolymer and processed by compression molding and sintering.

In still other implementations, the slurry technique is employed to disperse particles (e.g., silica and alumina) onto melt-processible fluoropolymer powder particles, which are either melt-processed directly to form a composite body or used as an intermediate that is let down in a melt processing operation with additional melt-processible fluoropolymer powder particles without the particle additions. The additional fluoropolymer particles may be of the same or different type.

### Tribological Testing

The wear resistance and coefficient of friction data shown herein are obtained using samples produced in accordance with the following procedure.

The samples are formed in a mold that produces samples in the form of a right circular cylinder, which may have a length of about 25 mm. Wear-measurement samples having the form of a pin and measuring about 6.4 mm×6.4 mm×12.7 mm are machined out of the interior of the compression molded cylinders using a laboratory numerically controlled milling machine. The finished samples are then measured and weighed; a density of each sample is calculated from these measurements. Only one sample is made from each compression-molded cylinder.

The wear resistance is tested against a counterface in the form of a plate made from 304 stainless steel and measuring about 38 mm×25.4 mm×3.4 mm. The counterface is lapped to produce a surface profile with about a 161 nm R rms (with a standard deviation of 35 nm). A linear reciprocating tribometer operated using LabVIEW™ software program control is used to test the composite material under dry sliding conditions according to embodiments of the present disclosure. The counterface is mounted to a table that reciprocates 25 mm in each direction and is positioned with a stepper motor and ball screw system.

Prior to testing, the counterfaces are washed in soap and water, sonicated for about 15 minutes in methanol, and then dried with a laboratory wipe. The composites are wiped down with methanol but are not washed or sonicated. The pin sample is mounted directly to a 6-channel load cell that couples to a linear actuator. The control system actuates two electro-pneumatic valves that pressurize the loading cylinder. Table position, pin displacement, friction force and normal force are recorded with the same software. The normal load applied to the nominally square 6.4 mm×6.4 mm surface of the pin is 250 N, which corresponds to a nominal pressure of 6.25 MPa, and the sliding velocity is 50 mm/s. The entire apparatus is located inside a soft-walled clean room with conditioned laboratory air of relative humidity between 25-50%.

The mass of the pin is measured with a Mettler Toledo AX205 precision analytical balance that has a range of 220 g and a resolution of 10 μg. The mass loss of the sample, the density of the material, the total test sliding distance and the time averaged normal load are used to calculate the wear rate with the following equation:

$$k [ \frac{{mm}^{3}}{Nm} ] = \frac{mass loss [ mg ] / ρ [ \frac{mg}{{mm}^{3}} ]}{F [ N ] * d [ m ]}$$

The tests are interrupted periodically so the sample can be weighed. A steady state wear rate is determined as the wear rate once the material runs in. “Running in” is a time towards the beginning of testing where a transfer film is being developed and a slightly higher mass loss rate is observed. It is observed that after the initial run-in, the wear rate is relatively constant.

Wear measurements are made using two methods: a mass loss method and a direct height loss measurement. For a mass loss measurement, a sample is massed both before and after sliding occurs. Based on the change in mass and the density of the material, a volume loss and wear rate is obtained. A displacement based measurement is complementary to the mass based measurement. A linear variable differential transformer (LVDT) monitors a height change of the sample, which can be equated to a volume and wear rate measurements. It should be noted that for these materials, the low wear rate requires at least 50,000 km of sliding for accurate wear measurements to be obtained. It should also be noted that more ideal counter materials and material finishes can generate lower wear rates.

In an embodiment, the steady state wear rate of an article made of a free-sintered composite mixture of PTFE, Al₂O₃ particles (i.e., d₅₀ (median diameter) of less than 500 nm and about 0.01 to 20 weight percent of the composite mixture), and fumed silica particles (i.e., d₅₀ (median diameter) of less than 200 nm and 0.01 to 10 weight percent of the composite mixture) can be about 1×10⁻⁷ mm³/Nm, when measured at a nominal pressure of 6.25 MPa and 50.8 mm/s sliding velocity against a lapped 304 stainless steel plate counter-surface. In the same embodiment the friction coefficient is about 0.1 to 0.27. In addition, the friction coefficient is about 0.1 to 0.27 when the counter-surface is titanium, or glass.

Although not intending to be bound by theory, it appears that the combination of the fluoropolymer, alumina particles, and fumed silica particles produces a synergistic effect on reducing the steady state wear rate. Although not intending to be bound by theory, the superior tribological properties of the articles may be the result of reactions occurring between or among the three components.

In an embodiment, articles made in accordance with the foregoing process can be used in low friction applications. The types of articles can vary greatly and include articles where reduced friction is advantageous. In general, an embodiment of the article can have one or more sliding surfaces or surfaces in contact with another structures surface. The articles can have a variety of shapes and cross sections. In an embodiment, the shape of the article can be a simple geometrical shape (e.g., spherical, polygonal, and the like) or a complex geometrical shape (e.g., irregular shapes). In general, the article can have a cross-sectional shape including, but not limited to, a polygon, a curved cross-section, irregular, and combinations thereof.

Embodiments of the articles can be used in many structures, parts, and components in the in the automotive, industrial, aerospace industries, and sporting equipment industries, to name but a few industries where articles having superior tribology characteristics are advantageous. The article can be used in many different applications including, but not limited to, mechanical parts (e.g., bearing, joins, pistons, etc), structures having load bearing surfaces, sporting equipment, machine parts and equipment, and the like.

It should also be noted that the tribological properties of articles of the present disclosure can be designed for a particular application. Thus, embodiments of the present disclosure can provide articles that can satisfy many different requirements for different industries and for particular components.

### EXAMPLES

Now having described the embodiments of the present disclosure, in general, the following Examples describe some additional embodiments of the present disclosure. While embodiments of present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

Materials:

Materials used in carrying out the examples include the following:

Isopropyl alcohol (IPA): Optima® grade (H₂O<0.020%, 0.2 μm filtered) stored over a 4 Å molecular sieve, Fisher Scientific, Pittsburgh, Pa.;

PTFE 7C powder: Teflon® PTFE 7C granular resin, DuPont Corporation, Wilmington, Del.

Submicron α-alumina: Stock #44652, Alfa Aesar, Ward Hill, Mass., represented by the manufacturer as having average particle size of 80 nm.

Fumed silica: Cab-O-Sil® M5, Cabot Corporation, Billerica, Mass., represented by the manufacturer as being a submicron powder.

### Comparative Example 1

### Processing of an Unloaded PTFE Sample

TEFLON® PTFE 7C powder was formed into a test sample using a compression molding and sintering technique consistent with the protocol of ASTM D-4894-07. The mold used had a cavity in the shape of a right circular cylinder with a diameter of about 2.86 cm. The mold was charged with about 12 g of the starting powder material. The powder was compressed with a loading of about 5000 psi and held at ambient temperature for 2 minutes to form a compact about 0.9 cm high.

The compressed-powder compact was then free-sintered to form the test sample. First, the mold containing the compact was placed into a 290° C. oven with a nitrogen purge. The oven temperature was immediately ramped up to 380° C. at a rate of 120° C./h and then held at 380° C. for 30 minutes. Thereafter, the specimen was cooled to 294° C. at a rate of 60° C./h and held at 294° C. for 24 minutes before removing it from the oven.

A sample suitable for wear testing was obtained from the sintered body by conventional machining techniques. Wear testing using the procedure set forth above gave a wear rate for the unloaded PTFE sample of K=3.74×10⁻⁴ mm³/N-m.

### Comparative Example 2

### Wear Resistance of a Fumed Silica/PTFE Composite Body

A sintered fumed silica/PTFE composite body was prepared generally in accordance with the procedures set forth in U.S. Pat. No. 7,790,658, which is incorporated herein in the entirety by reference thereto. In particular, a mixture of 5 wt. % fumed silica in TEFLON® PTFE 7C was prepared and passed twice through an alumina-lined Sturtevant jet mill. This milled powder was added to a 12.6 mm diameter vessel and consolidated in a press at 500 MPa applied pressure. The resulting compressed pellet was then sintered while under 2.5 MPa of pressure with the following temperature profile: ramp to 380° C. over 3 hours, hold at 380° C. for 3 hours, ramp to ambient temperature over 3 hours. A pin sample suitable for wear testing was obtained from the sintered body by conventional machining techniques. The wear resistance of this sample was determined to be 3.0×10⁻⁴ mm³/N-m using the procedure set forth above.

### Comparative Example 3

### Wear Resistance of an α-Alumina/PTFE Composite Body

A sintered α-alumina/PTFE composite body was prepared in accordance with the procedures set forth in U.S. Pat. No. 7,790,658. In particular, a mixture of 5 wt. % alpha-alumina in TEFLON® PTFE 7C was prepared, and passed twice through an alumina-lined Sturtevant jet mill. This powder was added to a 12.6 mm diameter vessel and consolidated in a press at 500 MPa applied pressure. The resulting compressed pellet was then sintered while under 2.5 MPa of pressure with the following temperature profile: ramp to 380° C. over 3 hours, hold at 380° C. for 3 hours, ramp to ambient temperature over 3 hours.

A pin sample of this material suitable for wear testing was obtained from the sintered body by conventional machining techniques. The wear resistance of this sample was determined to be 1.3×10⁻⁷ mm³/N-m using the procedure set forth above.

### Example 1

### Creation of a Composite Body Containing PTFE with Dispersed Submicron α-Alumina Additive Particles and Fumed Silica Particles Via an IPA Slurry Method

A precursor slurry containing approximately 3.45 wt. % of the same submicron particles of α-alumina as used in Comparative Example 3 was formed by adding 5.0 g of the particles to 140 g of IPA in a 200 mL bottle. After adding the submicron particles, the bottle was sonicated using an ultrasonic horn (Branson Digital Sonicator 450 with a titanium tip, operating at about 40% amplitude (400W)). The mixture was subjected to 3 cycles of 1 min duration, with a 45 sec relaxation interval after each cycle. The result was a milky dispersion with no visible particles.

Quickly thereafter, 97.2 g of this slurry (to provide 3.35 g of alumina) was added to a 500 mL pear-bottom flask which already contained 3.35 g fumed silica and 60.0 g of the same PTFE 7C granular powder used to prepare the samples of Comparative Examples 1 and 2. The amount of slurry was selected to provide an alumina level of 5.0 wt. % and a fumed silica level of 5.0 wt. % in the final PTFE/alumina/silica mixture. The flask wall was rinsed with an additional 100 mL of IPA to clear the flask wall. The flask was then gently swirled for a few minutes to assure mixing of the PTFE powder, fumed silica, and IPA/alumina slurry.

Then the PTFE powder/fumed silica/IPA-alumina slurry mixture was dried in the flask using a rotary evaporator. Pressure was slowly reduced and the water bath heated to 55° C. to evenly evaporate and remove the polar organic liquid, while carefully avoiding bumping. The slurry continued to mix as the polar organic liquid was removed. The resulting powder was further dried for four hours at 50° C. under high vacuum (4 Pa≈30 milliTorr) for 4 hours to remove any residual water and/or IPA. The dried composite powder material was free flowing.

A test sample was then prepared using the dried composite PTFE powder/fumed silica/IPA-alumina powder material using a compression molding and sintering technique consistent with the protocol of ASTM D-4894-07. The mold used had a cavity in the shape of a right circular cylinder with a diameter of about 2.86 cm. The mold was charged with about 12 g of the starting powder material. The powder was compressed with a loading of about 35 MPa and held at ambient temperature for 2 minutes to form a compact about 0.9 cm high.

The compressed-powder compact was then sintered to form the test sample. First, the mold containing the compact was placed into a 290° C. oven with a nitrogen purge. The oven temperature was immediately ramped up to 380° C. at a rate of 120° C./h and then held at 380° C. for 30 minutes. Thereafter, the specimen was cooled to 294° C. at a rate of 60° C./h and held at 294° C. for 24 minutes before removing it from the oven.

A sample suitable for wear testing was obtained from the sintered body by conventional machining techniques.

### Example 2

### Creation of a Composite Body Containing PTFE with Dispersed Submicron α-Alumina Additive Particles and Fumed Silica Particles Via a Jet Milling Method

A composite powder material containing PTFE with dispersed submicron α-alumina additive particles and fumed silica particles was prepared generally in accordance with procedures set forth in U.S. Pat. No. 7,790,658. In particular, the same PTFE 7C powder, submicron α-alumina additive particles, and fumed silica particles used to form the composite powder of Example 1 were used. A mixture of the requisite amount of each material to provide 5 wt. % of the submicron α-alumina and 5 wt. % of the fumed silica in PTFE was prepared and passed twice through an alumina-lined Sturtevant jet mill. This milled powder was added to a 12.6 mm diameter vessel and consolidated in a press at 500 MPa applied pressure. The resulting compressed pellet was then free sintered using the following temperature profile: ramp to 380° C. over 3 hours, hold at 380° C. for 3 hours, ramp to ambient temperature over 3 hours.

### Example 3

### Wear Testing of Composite Bodies Containing Alumina, Silica, and PTFE

Pin samples suitable for wear testing were prepared from the PTFE composite bodies of Examples 1 and 2 using conventional machining techniques. The coefficient of sliding friction and wear rate if each sample was tested in accordance with the procedure set forth above and compared with results for the unfilled PTFE sample of Comparative Example 1 and the PTFE with 5 wt. % alumina/PTFE and 5 wt. % silica/PTFE samples of Comparative Examples 2 and 3, respectively. The results obtained are set forth in the following table:

TABLE I
Friction and Wear Data for PTFE Samples

| | K | |
|---|---|---|
| Example | (mm³/N-m) | μ |
| 1 | 2.82 × 10⁻⁸ | 0.23 |
| 2 | ~4 × 10⁻⁸ | ~0.23 |
| Comparative 1 | 3.74 × 10⁻⁴ | 0.13 |
| Comparative 2 | ~3 × 10⁻⁴ | ~0.13 |
| Comparative 3 | ~1 × 10⁻⁷ | ~0.2 |

It can be seen that samples containing a combination of alumina and silica in PTFE exhibit wear rates that are reduced from that of unfilled PTFE by as much as 10,000 times or more. By including 5 wt % fumed silica filler, an already ultra-low wear PTFE and alumina composite can be reduced in wear by an order of magnitude to 2.82×10⁻⁸ mm³/N-m.

### Example 4

The Table in Example 4 illustrates wear resistance data for fluoropolymer composites containing metal oxide and/or silica fillers. The data was obtained according to the tribometer testing noted above.

| | Best wear | Coeff | Effect |
|---|---|---|---|
| Description | rate | Friction | of SiO₂ |
| PFA 340 | 3.60E−04 | 0.277 | |
| PFA 340 + 5% Al₂O₃ (Sample C) | 2.40E−05 | 0.256 | |
| PFA 340 + 5% Al₂O₃ (Sample C) + | 6.48E−05 | 0.243 | Worse |
| 5% SiO₂ | | | |
| PTFE 7C | 4.30E−04 | 0.129 | |
| PTFE 7C + 5% Al₂O₃ (Sample A) | 6.78E−08 | 0.200 | |
| PTFE 7C + 5% Al₂O₃ (Sample A) + | 2.92E−08 | 0.238 | Better |
| 5% SiO₂ | | | |
| PTFE 7C + 5% TiO₂ (DLS210) | 1.43E−05 | 0.225 | |
| PTFE 7C + 5% TiO₂ (DLS210) + | 5.49E−04 | 0.163 | Worse |
| 5% SiO₂ | | | |
| PTFE 7C + 5% TiO₂ (uncoated rutile#2) | 1.01E−07 | 0.289 | |
| PTFE 7C + 5% TiO₂ (uncoated rutile#2) + | 1.13E−07 | 0.261 | No |
| 5% SiO₂ | | | effect |

### Submicron α-Alumina:

Sample A: Stock #44652, Alfa Aesar, Ward Hill, Mass., represented by the manufacturer as having an approximate particle size of 60 nm.

Sample B: Stock #44653, Alfa Aesar, Ward Hill, Mass., represented by the manufacturer as having an approximate particle size of 27-43 nm.

Sample C: Stock #42573, Alfa Aesar, Ward Hill, Mass., represented by the manufacturer as having an approximate particle size of 350-490 nm. (No measurement method was indicated by the manufacturer for determining the average particle size.)

Rutile TiO₂: Prepared by a laboratory precipitation process, yielding a size distribution with a d₅₀ value of 160 nm as measured by dynamic light scattering.

DLS210 is a surface treated high rutile ultrafine titanium dioxide with a mean particle size of 135 nm. Available from DuPont Corporation.

SiO₂ is Cab-O-Sil M5, a medium surface fumed silica purchased from Acros Organics.

PFA 340: Teflon® PFA 340: perfluoroalkoxy resin (DuPont Corporation, Wilmington, Del.), which is loosely compacted fluff that has not been melt-processed.

PTFE 7C powder: Teflon® PTFE 7C polytetrafluoroethylene granular resin (DuPont Corporation, Wilmington, Del.).

### Example 5

The Table in Example 5 illustrates wear resistance data for fluoropolymer composites containing metal oxide and/or silica fillers. Sample A and alumina are the same as described in Example 4. The data was obtained using Falex testing as described below.

| | Total Wear | friction | Sliding distance |
|---|---|---|---|
| | rate | Coefficient | (m) |
| PTFE control | 4.66E−04 | 0.106 | 500 |
| PTFE 7C/5% Sample A | 1.58E−07 | 0.156 | 13,000 |
| alumina/5% | | | |
| fumed silica | | | |

### Falex Wear Resistance Testing:

Falex block-on-ring wear testing reported herein was carried out using equipment and a testing protocol consistent with ASTM Test methods D2714-94 and G137-97. Samples were prepared in the form of an arcuate block shaped to conform to the geometry of the circular surface of a Falex #1 ring and run at a pressure of 6.25 MPa and a velocity of 50.8 mm/s.

A related characterization of the wear behavior of materials is provided by a so-called PV limit, by which is meant a value of pressure times velocity within which a bearing couple must operate to provide acceptable performance. Such testing may conveniently be carried out using a Falex Ring and Block Wear and Friction Tester. This equipment and the associated testing protocol are described in ASTM Test methods D2714-94 and G137-97. Generally stated, a block of material to be tested is mounted against a rotating metal ring and loaded against it with a selected test pressure. The ring is then spun, with the wear being determined by weighing the test block before the test and at selected intervals thereafter. The Falex wear rate may calculated from the following equation:

$$wear rate ( {cm}^{3} \text{/} hr ) = \frac{weight loss ( g )}{density ( g \text{/} {cm}^{2} ) \times test duration ( h )} \qquad ( 3 )$$

The PV limit is conventionally regarded as the value of pressure times velocity at which failure occurs. The PV limit of a body is typically determined by carrying out a wear exposure while increasing either or both parameters until a rapid and uncontrollable rise in friction occurs. Exemplary use of Falex testing is provided by U.S. Pat. No. 5,179,153 (col. 4, lines 25-50) and U.S. Pat. No. 5,789,523 (col. 4, line 63ff), each of which is incorporated herein in their entirety.

The Falex wear rate given by Equation (3) can be converted to the coefficient of wear resistance, or specific wear rate, k of Equation (2). As recognized by one of ordinary skill, wear rates determined by different testing methods ordinarily are correlated, but the exact numerical values depend somewhat on particular test conditions.

It should be noted that some ratios, concentrations, amounts, and other numerical data are expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to measurement technique and/or the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

At least the following is claimed:

1. An article, comprising:
a composite including a fluoropolymer, metal oxide particles, and silica particles.

2. The article of claim 1, wherein the fluoropolymer is about 60 to 98 weight percent of the composite, the metal oxide particles are about 1 to 20 weight percent of the composite, and the silica particles are about 1 to 20 weight percent of the composite.

3. The article of claim 1, wherein the metal oxide is one of α-alumina or rutile.

4. The article of claim 3, wherein the metal oxide is α-alumina.

5. The article of claim 1, wherein the article has a steady state wear rate of about 3×10⁻⁸ mm³/N-m or less, when measured at 6.25 MPa normal pressure and 50.8 mm/s sliding velocity against a lapped stainless steel countersurface.

6. The article of claim 1, wherein the article has a steady state wear rate of about 1×10⁻⁷ mm³/Nm or less, when measured at 6.25 MPa normal pressure and 50.8 mm/s sliding velocity against a lapped stainless steel countersurface.

7. The article of claim 1, wherein the metal oxide particles have a size distribution as determined by dynamic light scattering, wherein a d₅₀ value by volume is about 50 nm to about 500 nm, and/or a size distribution as determined by static light scattering wherein a d₅₀ value by volume is about 60 nm to about 1500 nm.

8. The article of claim 7, wherein the metal oxide particles have an average effective particle size as determined by a BET method of 80 nm or less.

9. The article of claim 7, wherein the d₅₀ value determined by dynamic light scattering or static light scattering is at least 2.5 times larger than the average particle size determined by a BET method.

10. The article of claim 9, wherein the size distribution of the metal oxide particles as determined by dynamic light scattering has a d₅₀ value of 220 nm or less and an average effective particle size as determined by a BET method of 80 nm or less.

11. The article of claim 1, wherein the fluoropolymer is not melt processible.

12. The article of claim 11, wherein the fluoropolymer is PTFE.

13. The article of claim 1, wherein the fluoropolymer is melt processible.

14. The article of claim 13, wherein the fluoropolymer is at least one of PFA or FEP.

15. A process for manufacturing an article comprising a composite portion, the process comprising:
creating a composite powder material by a process comprising:
creating a particle dispersion of additive particles comprising metal oxide particles and silica particles in a polar organic liquid,
mixing the particle dispersion with fluoropolymer powder particles to form a precursor slurry, and
drying the precursor slurry by removing the polar organic liquid to form the composite powder material, wherein the additive particles are associated with a surface of the fluoropolymer powder particles; and
forming the composite powder material into the composite portion of the article.

16. The process of claim 15, wherein the forming comprises compression molding and sintering the composite powder material to form the composite portion of the article.

17. The process of claim 15, wherein the forming comprises melt processing the composite powder material to form the composite portion of the article.

18. A composition, comprising:
a composite including a fluoropolymer, metal oxide particles, and silica particles.

19. The composition of claim 18, wherein the fluoropolymer is about 60 to 98 weight percent of the composite, the metal oxide particles are about 1 to 20 weight percent of the composite, and the silica particles are about 1 to 20 weight percent of the composite.

20. The composition of claim 18, wherein the fluoropolymer is not melt processible.

21. The composition of claim 20, wherein the fluoropolymer is PTFE.

22. The composition of claim 18, wherein the fluoropolymer is melt processible.

23. The composition of claim 22, wherein the fluoropolymer is at least one of PFA or FEP.
